(19) United States
(12) Patent Application Publication
(10) Pub. No.: US 2023/0014570 A1
(43) Pub. Date: Jan. 19, 2023

(54) ROUTE GENERATION DEVICE, METHOD, AND PROGRAM

(71) Applicant: DENSO CORPORATION, Kariya-city (JP)

(72) Inventors: Naohiro FUJIWARA, Kariya-city (JP); Makoto OHKADO, Kariya-city (KR); Tatsuya NAMIKIRI, Kariya-city (KR)

(21) Appl. No.: 17/936,275

(22) Filed: Sep. 28, 2022

Related U.S. Application Data
(63) Continuation of application No. PCT/JP2021/000170, filed on Jan. 6, 2021.

(30) Foreign Application Priority Data
Mar. 31, 2020 (JP) 2020-062621

(51) Int. Cl. B60W 50/00

(52) U.S. Cl. CPC B60W 50/00; B60W 2050/0075; B60W 2556/00

(57) ABSTRACT

A route generation device includes: an autonomous route generator configured to generate, based on surrounding information around an own vehicle detected by a vehicle-mounted detector, an expected autonomous route along which the own vehicle is to travel; a map route acquirer configured to acquire an expected map route along which the own vehicle is to travel based on map data; and an integrated route generator configured to generate an integrated route using the autonomous route and the map route.

### CROSS-REFERENCE TO RELATED APPLICATION

The present application is a continuation application of International Application No. PCT/JP2021/000170, filed on Jan. 6, 2021, which claims priority to Japanese Patent Application No. 2020-062621, filed on Mar. 31, 2020. The contents of these applications are incorporated herein by reference in their entirety.

### BACKGROUND

### Technical Field

The present disclosure relates to a route generation device, method, and program for generating an expected route along which an own vehicle is to travel.

### Background Art

An expected route along which an own vehicle is to travel is typically generated based on surrounding information around the own vehicle detected by a vehicle-mounted detector. It should be noted that regarding automatic control of an own vehicle speed, automatic control using camera information captured by a vehicle-mounted camera as vehicle-mounted detector, and map data stored in a map database is performed.

### SUMMARY

In the present disclosure, provided is a route generation device as the following.

The route generation device includes: an autonomous route generator configured to generate an expected autonomous route along which the own vehicle is to travel; a map route acquirer configured to acquire an expected map route along which the own vehicle is to travel; and an integrated route generator configured to generate an integrated route using the autonomous route and the map route.

### BRIEF DESCRIPTION OF THE DRAWINGS

The above-described object and other objects, features, and advantages of the present disclosure will be further clarified by the following detailed description with reference to the attached drawings. The drawings are:

FIG. 1 is a block diagram illustrating a route generation system of an embodiment of the present disclosure;

FIG. 2 is a flowchart illustrating a route generation method of the embodiment of the present disclosure;

FIG. 3 is a schematic diagram illustrating an autonomous route point sequence generation step of the embodiment of the present disclosure;

FIG. 4 is a schematic diagram illustrating a map route point sequence generation step of the embodiment of the present disclosure;

FIG. 5 is a schematic diagram illustrating a map route point sequence correction step of the embodiment of the present disclosure;

FIG. 6 is a schematic diagram illustrating an integrated route point sequence generation step of the embodiment of the present disclosure; and

FIGS. 7A to 7B are a joint schematic diagram illustrating an integrated route curve generation step of the embodiment of the present disclosure.

### DETAILED DESCRIPTION OF THE PREFERRED EMBODIMENTS

[PTL 1] U.S. Pat. No. 9,090,260

For example, in PTL 1 and the like, as a result of detailed studies by the inventors, the following problem has been found. That is to say, in a case where a route is generated only based on surrounding information around an own vehicle detected by a vehicle-mounted detector, no route can be generated for a region where surrounding information fails to be detected by the vehicle-mounted detector, resulting in occurrence of a missing part in the route. In contrast, in a case where a route is generated only based on map data, the generated route may be less reliable depending on update timing or area of the map data. Therefore, the own vehicle is unlikely to be appropriately controlled in line with either route.

An object of the present disclosure is to provide a route generation device, method, and program enabling generation of a route allowing for appropriately controlling an own vehicle.

A first embodiment of the present disclosure is a route generation device including: an autonomous route generator configured to generate, based on surrounding information around an own vehicle detected by a vehicle-mounted detector, an expected autonomous route along which the own vehicle is to travel; a map route acquirer configured to acquire an expected map route along which the own vehicle is to travel based on map data; and an integrated route generator configured to generate an integrated route using the autonomous route and the map route.

A second embodiment of the present disclosure is a route generation method including: a step of generating, based on surrounding information around an own vehicle detected by a vehicle-mounted detector, an expected autonomous route along which the own vehicle is to travel; a step of acquiring an expected map route along which the own vehicle is to travel based on map data; and a step of generating an integrated route using the autonomous route and the map route.

A third embodiment of the present disclosure is a route generation program configured to cause a computer to perform: a step of generating, based on surrounding information around an own vehicle detected by a vehicle-mounted detector, an expected autonomous route along which the own vehicle is to travel; a step of acquiring an expected map route along which the own vehicle is to travel based on map data; and a step of generating an integrated route using the autonomous route and the map route.

According to the present disclosure, it is possible to generate a route allowing for appropriately controlling an own vehicle.

### First Embodiment

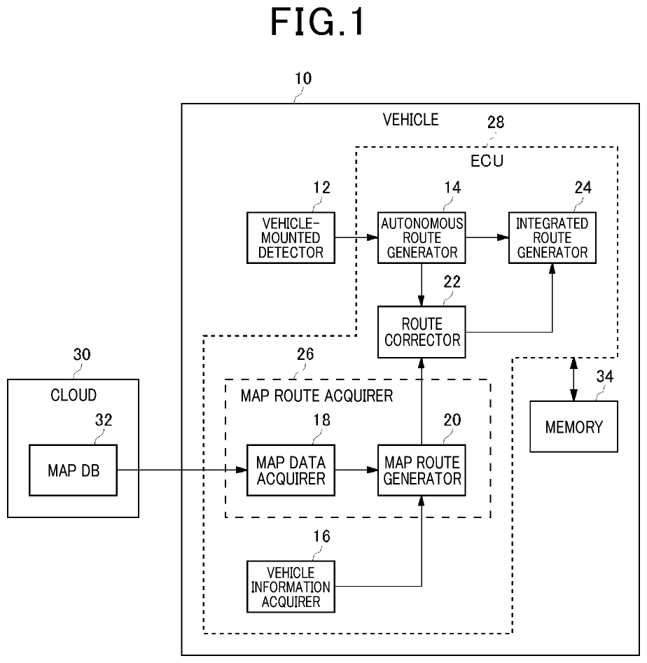

Description will be made on a first embodiment of the present disclosure with reference to FIG. 1 to FIG. 7B.

In the present embodiment, an autonomous route point sequence with a high reliability is generated based on surrounding information around an own vehicle detected by a vehicle-mounted detector, and a map route point sequence with no missing parts is generated based on map data acquired from a map database (hereinafter, referred to as “map DB”). Then, a corrected map route point sequence with an improved reliability is generated by fitting the map route point sequence to the autonomous route point sequence, and a missing part of the autonomous route point sequence is then compensated with the corrected map route point sequence, thereby generating an integrated route point sequence that is highly reliable and has no missing parts. Further, the weighting of the corrected map route point sequence is lightened with respect to the autonomous route point sequence corresponding to the map route point sequence having the low reliability with respect to the autonomous route point sequence, and then the integrated route point sequence, which includes the autonomous route point sequence and the compensated corrected map route point sequence, are connected to generate an integrated route curve.

A route generation system of the present embodiment will be outlined with reference to FIG. 1.

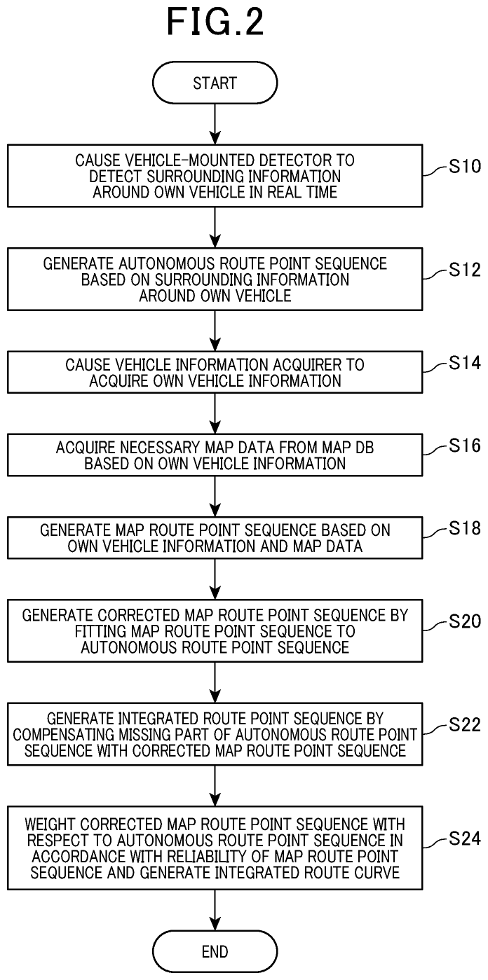

As illustrated in FIG. 1, in the route generation system, an own vehicle 10 includes a vehicle-mounted detector 12, an ECU (Electronic Control Unit) 28 as a computer, and a memory 34. The ECU 28, which includes one or more processors, is equipped with functions, as autonomous route generator 14, vehicle information acquirer 16, map route acquirer 26 (map data acquirer 18 and map route generator 20), route corrector 22, and integrated route generator 24. The memory 34, which is in the form of a non-volatile storage medium, stores a program that causes the ECU 28 to perform a process illustrated in a flowchart in FIG. 2 described later. In addition, a cloud 30, with which the map data acquirer 18 can communicate, includes a map database 32.

The vehicle-mounted detector 12 detects surrounding information around the own vehicle 10 and, in the present embodiment, a vehicle-mounted camera is used as the vehicle-mounted detector 12. The autonomous route generator 14 generates an expected autonomous route along which the own vehicle 10 is to travel based on the surrounding information around the own vehicle 10 detected by the vehicle-mounted detector 12. The autonomous route to be generated in the present embodiment is in the form of an autonomous route point sequence including a plurality of points sequentially indicating spots where the own vehicle 10 is to travel at time points after the current time point.

The vehicle information acquirer 16 acquires own vehicle information indicating a state of the own vehicle 10. In the present embodiment, the own vehicle information includes a location, orientation, and the like of the own vehicle 10. The map route acquirer 26 acquires a map route, which is an expected route (a second route) based on map data along which the own vehicle 10 is to travel. In the present embodiment, the map route acquirer 26 includes the map data acquirer 18 and the map route generator 20. The map data acquirer 18 acquires map data of an area around the own vehicle 10 from the map DB 32 on the cloud 30 and the map route generator 20 generates the map route based on the own vehicle information acquired by the vehicle information acquirer 16 and the map data acquired by the map data acquirer 18. In addition, the map route to be generated in the present embodiment is in the form of a map route point sequence including a plurality of points sequentially indicating spots where the own vehicle 10 is to travel at time points after the current time point. Here, since the map route point sequence is generated based on the map data without taking into account a result of detection by the vehicle-mounted camera 12, whereas the autonomous route point sequence is generated based on the surrounding information detected substantially in real time, the autonomous route point sequence is higher in reliability than the map route point sequence.

The route corrector 22 corrects the map route point sequence using the autonomous route point sequence generated by the autonomous route generator 14 and the map route point sequence acquired by the map route acquirer 26 to generate a corrected map route point sequence. It should be noted that the route corrector 22 may modify a part of the map route point sequence acquired by the map route acquirer 26 and then correct the modified map route point sequence to generate the corrected map route point sequence. In the present embodiment, the route corrector 22 fits of the map route point sequence to the autonomous route point sequence, thereby generating a corrected map route point sequence as a corrected map route.

The integrated route generator 24 integrates the corrected map route point sequence generated by the route corrector 22 with the autonomous route point sequence generated by the autonomous route generator 14 to generate an integrated route point sequence. In the present embodiment, the integrated route generator 24 compensates for a missing part of the autonomous route point sequence with the corrected map route point sequence, thereby generating the integrated route point sequence. Further, the integrated route generator 24 weights the corrected map route point sequence with respect to the autonomous route point sequence in accordance with the reliability of the map route point sequence and then connects the integrated route point sequence, which includes the autonomous route point sequence and a part of the compensated corrected map route point sequence, to generate an integrated route curve. Here, the integrated route curve to be generated is not necessarily a curve passing through all the sequence of points included in the integrated route point sequence and only has to pass near each point of the integrated route point sequence.

Description will be made on a route generation method of the present embodiment with reference to FIG. 2 to FIG. 7B.

As illustrated in FIG. 2, the ECU 28 executes the program read from the memory 34 to perform the route generation method including the following steps.

Surrounding Information Detection Step S10

In step S10, surrounding information around the own vehicle 10 is detected in real time by the vehicle-mounted detector 12. In the present embodiment, a camera image of a front side relative to the own vehicle is captured in real time by the vehicle-mounted camera.

Autonomous Route Point Sequence Generation Step S12

In step S12, an expected autonomous route point sequence along which the own vehicle 10 is to travel is generated based on the surrounding information around the own vehicle 10 detected in step S10. Here, the surrounding information around the own vehicle 10 detected in the surrounding information detection step S10, which is information detected in real time by the vehicle-mounted detector mounted to the own vehicle, has a high information accuracy, so that the autonomous route point sequence generated based on the surrounding information is also highly reliable. However, a region undetectable by the vehicle-mounted detector exists and the surrounding information is missing in the undetectable region, so that a missing part also occurs in the autonomous route point sequence generated based on the surrounding information.

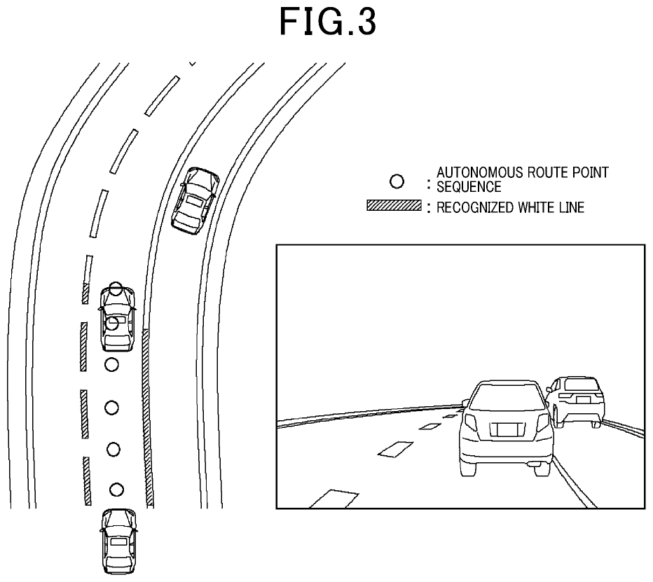

A detailed description will be given of step S12 of the present embodiment with reference to FIG. 3. In the present embodiment, the camera image of the front side relative to the own vehicle captured in real time by the vehicle-mounted camera 12 is analyzed, thereby recognizing a white line appearing in the camera image and generating the autonomous route point sequence based on the recognized white line. Here, the camera image captured in real time by the vehicle-mounted camera 12 has a high information accuracy, so that the autonomous route point sequence, which is generated based on the camera image, is also highly reliable. However, since a region where a field of view is blocked by a preceding vehicle or the like and a region out of a field of view, such as a front side in a travel direction over a sharp corner with a small radius of curvature, are not visible depending on the vehicle-mounted camera 12, a distant region in the travel direction is invisible in the present embodiment. In such an invisible distant region in the travel direction, even a white line cannot be recognized and thus a missing part also occurs in the autonomous route point sequence generated based on a recognized white line.

Vehicle Information Acquirement Step S14

In step S14, own vehicle information such as the location and orientation of the own vehicle is acquired. In the present embodiment, location information regarding the own vehicle 10 is acquired by a GPS and orientation information regarding the own vehicle 10 is acquired by an acceleration sensor (not illustrated) installed in the own vehicle 10.

Map Data Acquirement Step S16

In step S16, map data of an area around the own vehicle 10 is acquired from the map DB 32 on the cloud 30 based on the own vehicle information acquired in step S14. It should be noted that the map data in the present embodiment includes at least white line information that makes it possible to distinguish a lane of a road in a wide area.

Map Route Point Sequence Generation Step S18

In step S18, an expected map route point sequence along which the own vehicle 10 is to travel is generated based on the own vehicle information acquired in step S14 and the map data acquired in step S16. Here, in step S10, the own vehicle information or the map data has a lower information accuracy with respect to the surrounding information around the own vehicle 10 detected in real time by the vehicle-mounted detector mounted to the own vehicle, so that the reliability of the map route point sequence is also low with respect to the autonomous route point sequence generated based on the surrounding information in step S12. Meanwhile, the surrounding information is missing in a region undetectable by the vehicle-mounted detector and a missing part also occurs in the autonomous route point sequence generated based on the surrounding information, whereas no missing parts usually occurs in the map route point sequence generated based on the map data stored in the map DB 32.

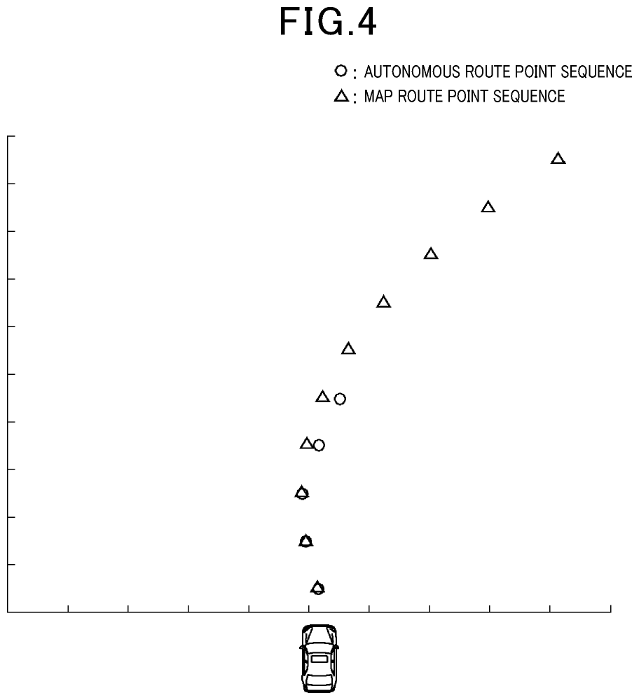

A detailed description will be given of step S18 of the present embodiment with reference to FIG. 4. In the present embodiment, the map route point sequence is generated based on the location information and the orientation information regarding the own vehicle 10, which are acquired by the GPS and the acceleration sensor, respectively, and the map data, which is acquired from the map DB 32. FIG. 4 illustrates that the autonomous route point sequence and the map route point sequence have an offset part, and the autonomous route point sequence ends on a near side as compared with the map route point sequence. Here, the information accuracies of the own vehicle information and the map data are low with respect to the camera image captured in real time by the vehicle-mounted camera 12, causing the reliability of the map route point sequence to be low with respect to the autonomous route point sequence, which is generated based on the camera image, with an error occurring in the map route point sequence with respect to the autonomous route point sequence. Meanwhile, a distant region in the travel direction is not visible depending on the vehicle-mounted camera 12 and even a white line cannot be recognized, so that a missing part also occurs in the autonomous route point sequence generated based on a recognized white line. In contrast to the above, the map route point sequence, which is generated based on the map data stored in the map DB 32, does not suffer from any missing parts even at a distant region in the travel direction.

Map Route Point Sequence Correction Step S20

In step S20, the map route point sequence generated in step S18 is corrected based on the autonomous route point sequence generated in step S12 to generate a corrected map route point sequence. Here, the autonomous route point sequence has a higher reliability than the map route point sequence, so that the corrected map route point sequence with an improved reliability can be obtained by correcting the map route point sequence based on the autonomous route point sequence. It should be noted that in step S20, the corrected map route point sequence may be generated by modifying a part of the map route point sequence generated in step S18 and then correcting the modified map route point sequence.

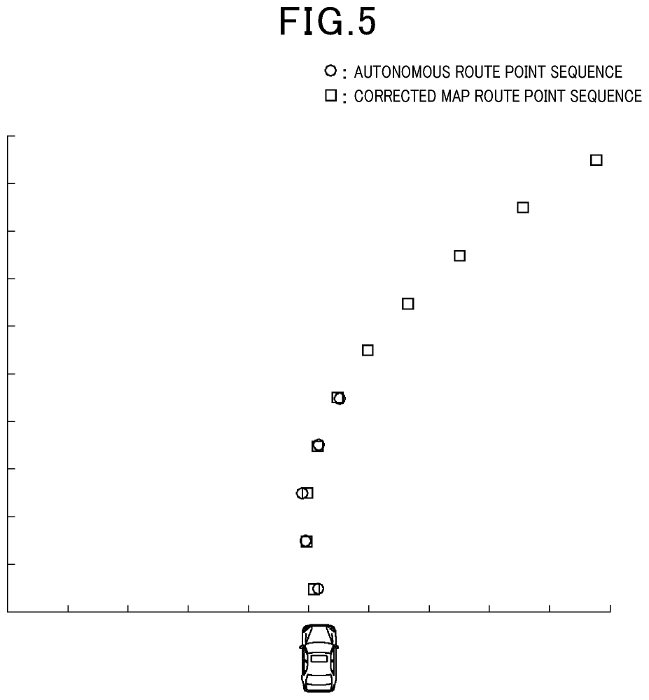

A detailed description will be made on step S20 of the present embodiment with reference to FIG. 5. In the present embodiment, the corrected map route point sequence is generated by fitting the map route point sequence to the autonomous route point sequence. Using an SVD (singular value decomposition), an ICP (interactive closest point), or the like as a fitting technique, a transformation matrix (R, t) for transforming the map route point sequence {xᵢ} into the corrected map route point sequence {yᵢ} is estimated as represented by Expression (1).

[Expression 1]

yᵢ=Rxᵢ+t (1)

Here, since the autonomous route point sequence is higher in reliability than the map route point sequence, the corrected map route point sequence with an improved reliability can be obtained by fitting the map route point sequence to the autonomous route point sequence to generate the corrected map route point sequence.

It should be noted that a map route point sequence provided by modifying a part of the map route point sequence generated in step S18 may be used as the map route point sequence {xᵢ} to be substituted into Expression (1) in the present embodiment. Examples of the modification of the map route point sequence include modifying positions of points of the map route point sequence such that a curve formed by connecting the map route point sequence becomes smooth with a curvature of the curve reduced.

Integrated Route Point Sequence Generation Step S22

In step S22, the corrected map route point sequence is integrated with the autonomous route point sequence to generate an integrated route point sequence. Here, the autonomous route point sequence is higher in reliability than the map route point sequence but has a missing part, whereas the map route point sequence is lower in reliability than the autonomous route point sequence but usually has no missing parts. Thus, the corrected map route point sequence, which is corrected based on the autonomous route point sequence to be improved in reliability, is integrated with the autonomous route point sequence, which makes it possible to obtain the integrated route point sequence that is highly reliable and has no missing parts.

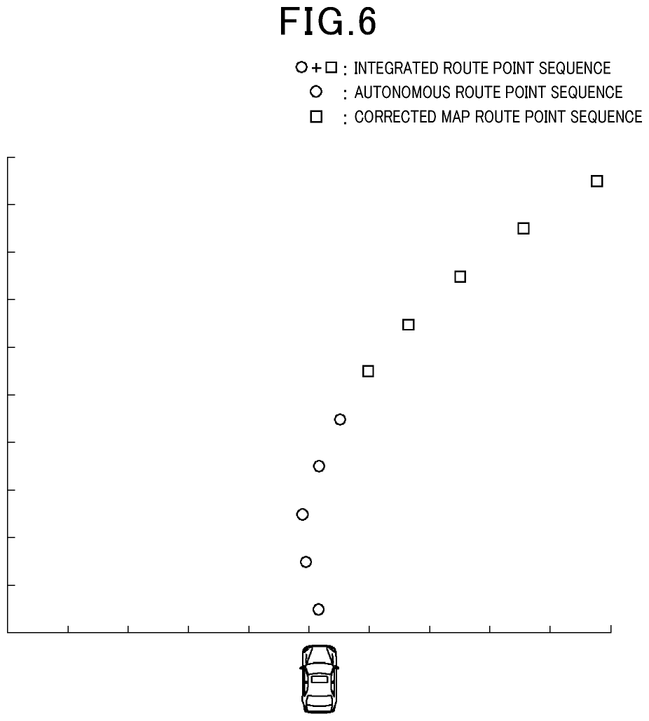

A detailed description will be given of step S22 of the present embodiment with reference to FIG. 6. In the present embodiment, the missing part of the autonomous route point sequence is compensated with the corrected map route point sequence to generate the integrated route point sequence. Here, the autonomous route point sequence is higher in reliability than the map route point sequence but has a missing part at a distant region in the travel direction, whereas the map route point sequence is lower in reliability than the autonomous route point sequence but has no missing parts even at the distant region in the travel direction. Thus, the missing part of the distant region in the travel direction in the autonomous route point sequence is compensated with the corrected map route point sequence, which is fitted to the autonomous route point sequence to be improved in reliability, thereby obtaining the integrated route point sequence that is highly reliable and has no missing parts even at the distant region in the travel direction.

Integrated Route Curve Generation Step S24

In step S24, the corrected map route point sequence is weighted with respect to the autonomous route point sequence in accordance with the reliability of the map route point sequence and then the integrated route point sequence, which includes the autonomous route point sequence and a part of the compensated corrected map route point sequence, is connected to generate an integrated route curve. Here, the weighting of the corrected map route point sequence is lightened with respect to the autonomous route point sequence corresponding to the map route point sequence having the low reliability with respect to the autonomous route point sequence, and then the integrated route point sequence, which includes the autonomous route point sequence and a part of the compensated corrected map route point sequence, is connected, which makes it possible to generate the integrated route curve with a high reliability.

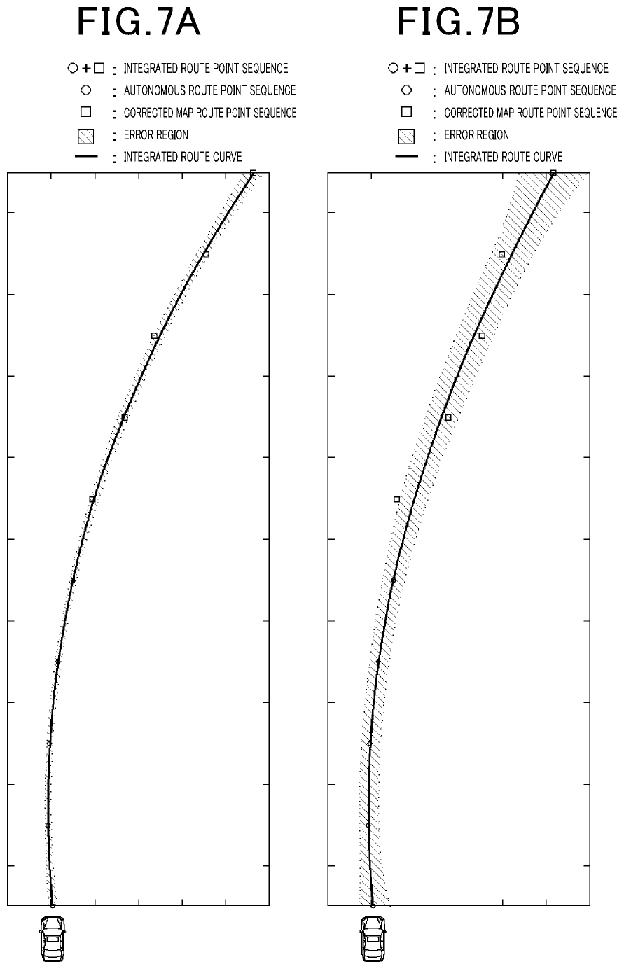

A detailed description will be given of step S24 of the present embodiment with reference to FIGS. 7A to 7B. It should be noted that FIG. 7A illustrates a case where the map route point sequence is relatively high in reliability and has a small error and FIG. 7B illustrates a case where the map route point sequence is relatively low in reliability and has a large error as compared with in the case in FIG. 7A. In the present embodiment, the corrected map route point sequence is weighted with respect to the autonomous route point sequence by an optimization technique, such as a weighted non-linear least-squares method, in accordance with the reliability of the map route point sequence based on the information accuracy of the own vehicle information, the information accuracy of the map data, and the like and then an n-th order curve connecting the integrated route point sequence, which includes the autonomous route point sequence and a part of the compensated corrected map route point sequence, is estimated to generate the integrated route curve. In this manner, the weighting of the corrected map route point sequence is lightened with respect to the autonomous route point sequence corresponding to the map route point sequence having the low reliability with respect to the autonomous route point sequence, and then the n-th order curve connecting the integrated route point sequence, which includes the autonomous route point sequence and a part of the compensated corrected map route point sequence, is estimated to obtain the integrated route curve with a high reliability.

Here, the map data included in the map DB 32 is different in updating timing depending on areas and thus the information accuracy is different depending on areas. Accordingly, the reliability of the map route point sequence is determined based on the information accuracy of the map data of an area acquired at the time when the map data acquirer 18 acquires the map data.

The route generation system and method of the present embodiment achieve the following effects.

In the route generation system and method of the present embodiment, the autonomous route point sequence with a high reliability is generated based on the surrounding information around the own vehicle 10 detected by the vehicle-mounted camera 12 and the map route point sequence with no missing parts is generated based on the map data acquired from the map DB 32. Then, the corrected map route point sequence with an improved reliability is generated by fitting the map route point sequence to the autonomous route point sequence and then a missing part of the autonomous route point sequence is compensated with the corrected map route point sequence, thereby generating the integrated route point sequence that is highly reliable and has no missing parts. Further, the weighting of the corrected map route point sequence is lightened with respect to the autonomous route point sequence corresponding to the map route point sequence having the low reliability with respect to the autonomous route point sequence, and then the integrated route point sequence, which includes the autonomous route point sequence and the compensated corrected map route point sequence, is smoothly joined to generate the integrated route curve with a high reliability. Therefore, it is possible to generate a route allowing for appropriately controlling the own vehicle 10.

### Second Embodiment

Hereinafter, description will be given of a second embodiment of the present disclosure.

Unlike in the first embodiment, the own vehicle 10 includes no route corrector 22 and does not without correct the map route point sequence, and the integrated route generator 24 generates an integrated route using a map route point sequence generated by the map route generator 20 and an autonomous route point sequence generated by the autonomous route generator 14 in the present embodiment.

Further, the integrated route generator 24 generates an integrated route point sequence based on a relationship in reliability between the map route point sequence and the autonomous route point sequence. For example, in a case where the reliability of the autonomous route is twice as high as the reliability of the map route, points where line segments each connecting a map route point and an autonomous route point at the same time point are internally divided at 2:1 are sequentially obtained to generate an integrated route point sequence and the integrated route point sequence is connected to generate an integrated route curve. Here, in a case where only a map route point sequence exists on a distant side, a position of an integrated route point relative to a map route point on the distant side may be determined based on an offset of an integrated route point relative to a map route point on a near side.

In the present embodiment, it is also possible to generate an integrated route that is highly reliable and has fewer missing parts as compared with in a case where only one of the autonomous route point sequence and the map route point sequence is used. This enables generating a route allowing for appropriately controlling the own vehicle 10.

### Other Embodiments

In the above-described embodiments, a vehicle-mounted camera is used as the vehicle-mounted detector. Alternatively, at least one sensor among a millimeter-wave radar, a LiDAR (Light Detection and Ranging, Laser Imaging Detection and Ranging), a sonar, and the like or the at least one sensor and a vehicle-mounted camera may be used as the vehicle-mounted detector.

In the above-described embodiments, map data is stored in the map DB 32 in the cloud 30, the map data acquirer 18 of the map route acquirer 26 of the own vehicle 10 acquires the map data from the map DB 32, and the map route generator 20 generates a map route from the map data. Alternatively, with a map route stored in the map DB 32 in the cloud 30, the map route acquirer 26 of the own vehicle 10 may directly acquire the map route from the map DB 32. In this case, the map route acquirer 26 does not need to have a function corresponding to the map route generator 20. Incidentally, in a case where the own vehicle 10 can have a sufficient data capacity, map information such as map data and map route to be held in the map DB 32 may be stored in the memory 34 of the own vehicle 10.

In the above-described embodiments, in a case where the reliability of the autonomous route point sequence is higher than the reliability of the map route point sequence, the corrected map route point sequence is generated by correcting the map route point sequence based on the autonomous route point sequence. Alternatively, in a case where the reliability of the map route point sequence is higher than the reliability of the autonomous route point sequence, or the like, a corrected route, or corrected autonomous route point sequence, may be generated by correcting the autonomous route point sequence based on the map route point sequence.

In the first embodiment, the corrected map route point sequence may be generated by modifying a part the map route point sequence and then correcting the modified map route point sequence. Alternatively or additionally, the integrated route point sequence may be generated by modifying the autonomous route point sequence and/or the corrected map route point sequence and then using the modified autonomous route point sequence and/or corrected map route point sequence. Incidentally, in the second embodiment, the integrated route point sequence may be generated by modifying the autonomous route point sequence and/or the map route point sequence and then using the modified autonomous route point sequence and map route point sequence.

In the embodiments, as illustrated in FIG. 4, FIG. 5, and the like, various routes such as the autonomous route, the map route, the corrected map route, and the integrated route are information sequentially indicating spots where the own vehicle is to travel at time points after the current time point; however, a manner of expressing the various routes is not limited thereto. The various routes may be information sequentially indicating expected speeds or expected accelerations of the own vehicle at time points after the current points as long as the travel of the own vehicle can be controlled, accordingly.

In the embodiments, the route point sequence is used as a route but a route curve may alternatively be used. In other words, although the autonomous route point sequence, the map route point sequence, the corrected map route point sequence, and the integrated route point sequence and the integrated route curve are used as the autonomous route, the map route, the corrected map route, and the integrated route, respectively, in the present embodiment, an autonomous route curve, a map route curve, a corrected map route curve, and an integrated route curve may alternatively be used.

In the embodiments hereinabove, a route generation system and method are described; however, a program that causes a computer to implement functions of the system or a program that causes a computer to perform steps of the method are within the scope of the present disclosure.

Although the present disclosure is described with reference to embodiments, it should be understood that the present disclosure is not limited to the embodiments and structures. The present disclosure embraces various modifications examples and modifications within the range of equivalency. Additionally, various combinations and forms and, further, other combinations and forms including only a single element or more or less in addition thereto are also within the spirit and scope of the present disclosure.

What is claimed is:

1. A route generation device comprising:
an autonomous route generator configured to generate, based on surrounding information around an own vehicle selected from between the surrounding information and map data, an expected autonomous route along which the own vehicle is to travel, the surrounding information being detected by a vehicle-mounted detector;
a map route acquirer configured to acquire an expected map route along which the own vehicle is to travel based on the map data selected from between the surrounding information and the map data; and
an integrated route generator configured to generate an integrated route using the autonomous route and the map route.

2. The route generation device according to claim 1, further comprising
a route corrector configured to generate a corrected route using the autonomous route and the map route by correcting a first route, the first rout being a less reliable one of the map route and the autonomous route, wherein
the integrated route generator is configured to integrate a second route and the corrected route to generate the integrated route, the second route being the other one of the map route and the autonomous route.

3. The route generation device according to claim 2, wherein
the route corrector is configured to fit the first route to the second route to generate the corrected route.

4. The route generation device according to claim 2, wherein
the second route is the autonomous route, and
the integrated route generator is configured to compensate for a missing part of the autonomous route with the corrected route to generate the integrated route.

5. The route generation device according to claim 4, wherein
the first route is the map route,
the integrated route generator is configured to weight the corrected route with respect to the autonomous route in accordance with a reliability of the map route and then generate the integrated route by connecting a part of the corrected route used to compensate for the missing part of the autonomous route and the autonomous route.

6. The route generation device according to claim 1, wherein
the integrated route generator is configured to generate the integrated route based on a relationship in reliability between the autonomous route and the map route.

7. A route generation method comprising:
a step of generating, based on surrounding information around an own vehicle selected from between the surrounding information and map data, an expected autonomous route along which the own vehicle is to travel, the surrounding information being detected by a vehicle-mounted detector;
a step of acquiring an expected map route along which the own vehicle is to travel based on the map data selected from between the surrounding information and the map data; and
a step of generating an integrated route using the autonomous route and the map route.

8. A route generation program configured to cause a computer to perform:
a step of generating, based on surrounding information around an own vehicle selected from between the surrounding information and map data, an expected autonomous route along which the own vehicle is to travel, the surrounding information being detected by a vehicle-mounted detector;
a step of acquiring an expected map route along which the own vehicle is to travel based on the map data selected from between the surrounding information and the map data; and
a step of generating an integrated route using the autonomous route and the map route.
